(19) United States
(12) Patent Application Publication
(10) Pub. No.: US 2024/0362332 A1
(43) Pub. Date: Oct. 31, 2024

(54) SYSTEMS AND METHODS FOR RULE AND PROTOCOL MANAGEMENT USING SOFT-CODED RULES IN NON-PERSISTENT RUN-TIME FILES

(71) Applicant: Capital One Services, LLC, McLean, VA (US)

(72) Inventors: Mahendher GOVINDASINGH KRISHNASINGH, Brambleton, VA (US); Maksym BEZKOROVAINYI, Ashburn, VA (US)

(73) Assignee: Capital One Services, LLC, McLean, VA (US)

(21) Appl. No.: 18/309,748

(22) Filed: Apr. 28, 2023

(51) Int. Cl. G06F 21/57; G06F 21/54

(52) U.S. Cl. CPC G06F 21/57; G06F 21/54

(57) ABSTRACT

Methods and systems are described herein for dynamic rule management without using hard-coded rules. A system may store, for example, in a persistent memory database, a first rule and receive a first request to process first input data using the first rule. In response to the first request, the system may retrieve a first rule template and initiate a first rule engine session. The system may generate, upon initiating first rule engine session, in a non-persistent memory database, a first non-persistent run-time file for validating the first input data using the first rule template. The first input data may be validated using the first non-persistent run-time file. The system may generate, for display, on a user interface, a validation confirmation for the first input data and end the first rule engine session.

### SUMMARY

In computer systems, data often requires validation prior to the data being released into the wider computer ecosystem. For example, releases of new applications (e.g., production releases for software) may need to be validated to ensure that the software is functioning as intended and meets various requirements of users. When such data is input as part of a request to be validated, such data is validated against various rules related to cyber security, risk analysis, and/or system auditing. Validating data such as software can help identify performance issues that may not have been apparent during development or testing of the software.

Failure to properly validate inputted data could potentially expose the system to security threats, cause high resource usage, slow response times, and/or otherwise cause unexpected issues that impact the overall performance of the software. In rule-based software validation, there are several controls that can be implemented and modified to ensure that the software is functioning as intended and meets the requirements of users. For example, controls may include various measures or checks for validating safety and compliance of release changes before it is allowed to go into production and/or integrate with preexisting software. These controls may include risk management and auditing functions to ensure that the change does not introduce any unacceptable risks or violate any regulations.

In existing frameworks, such controls are defined as hard-coded rules in a file. As such, each time a new application, production release, and/or other data is input for validation, the controls are modified or parametrized each time for specific input data to determine whether to allow the specific application, production release, or other data to proceed to be used in a system at large. Because these rules and controls are dynamic and can be changed at any time, there is a significant effort to manage these rules stored in a file. Any updates to these rules require careful editing and testing prior to deployment. Furthermore, as each file of hard-coded rules is being edited (e.g., to adjust each control) and/or being used for validation, the file is unavailable for validation purposes. This leads to significant idle time during validation and releasing procedures waiting on rules files to become available.

Accordingly, methods and systems are described herein for rule and protocol management that avoids use of hard-coded files and enables validation while one or more files are being edited and/or used in testing. In particular, the system and methods relate to using soft-coded rules in non-persistent run-time files.

For example, as opposed to relying on hard-coded files, the system and methods described herein analyze the inputted data using a rules template in order to determine whether any validation rules need to be applied and/or identify required validation rules. The rules template may define numerous characteristics about how and what inputted data is validated. For example, the rules template may reference one or more rules for validation stored in persistent memories (e.g., different versions of rules to be used in validation). The system then creates a non-persistent run-time file that includes any current (or selected) versions of the validation rules (e.g., pulled from a persistent database that stores a hard-coded rule) and initiates a rule engine session specific to the validation of the inputted data. As the rule engine session is specific to the validation of the inputted data, and the rule engine session uses the rules stored in the non-persistent run-time file (e.g., as opposed to the persistent database), the rules in the persistent database may be freely edited and/or tested while validation on inputted data is ongoing.

In some aspects, a method is provided for dynamic rule management without using hard-coded rules. The method may include storing, in a persistent memory database, a first rule, such as a validation requirement for input data. The method may further include receiving a first request to process first input data, such as software for a production release, using the first rule (e.g., validation requirements). In response to the first request, the method may include retrieving a first rule template and initiating a first rule engine session. Upon initiating the first rule engine session, the method includes generating, in a non-persistent memory database, a first non-persistent run-time file for validating the first input data using the first rule template. The method includes validating the first input data using the first non-persistent run-time file. The method further includes ending the first rule engine session.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRA WINGS

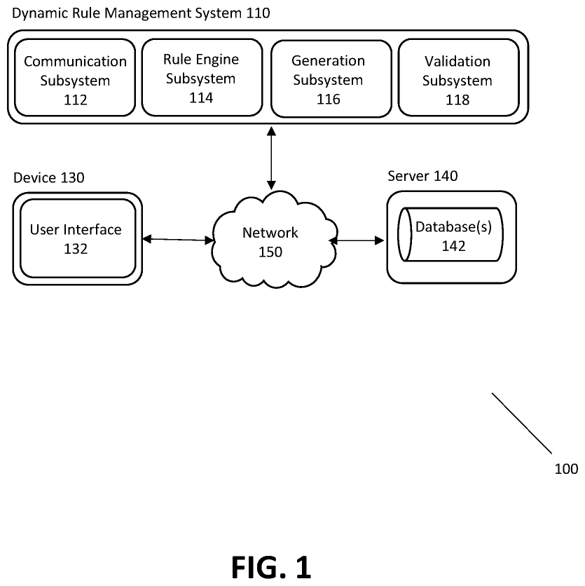

FIG. 1 shows an illustrative system for rule and protocol management using soft-coded rules in non-persistent run-time files, in accordance with one or more embodiments of this disclosure.

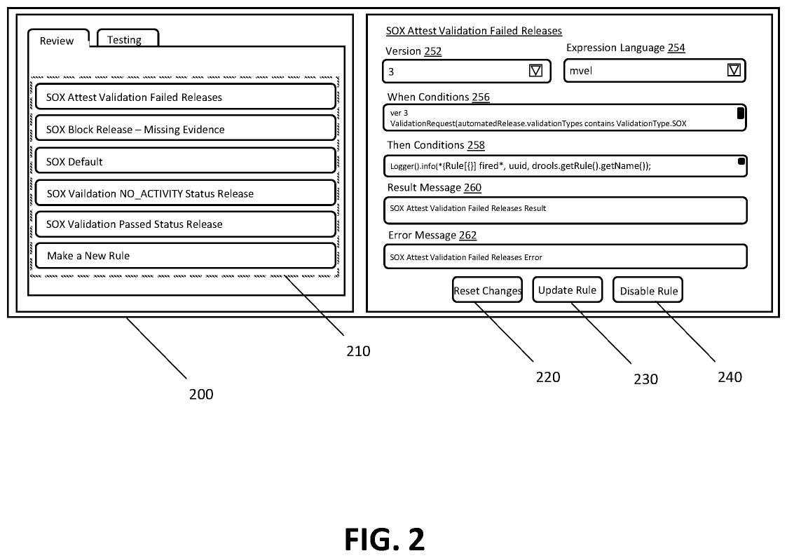

FIG. 2 illustrates an example of a user interface for rule and protocol management using soft-coded rules in non-persistent run-time files, in accordance with one or more embodiments of this disclosure.

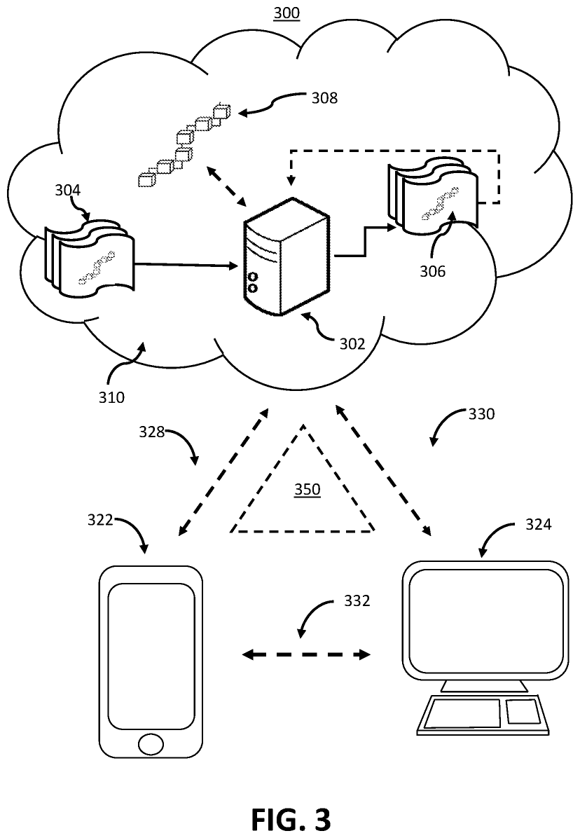

FIG. 3 shows illustrative components for a system used for rule and protocol management using soft-coded rules in non-persistent run-time files, in accordance with one or more embodiments.

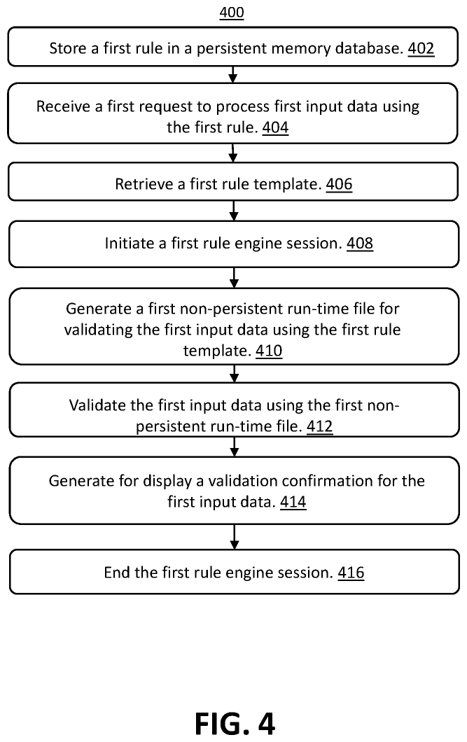

FIG. 4 is a flowchart of operations for managing rules and protocols using soft-coded rules in non-persistent run-time files, in accordance with one or more embodiments of this disclosure.

### DETAILED DESCRIPTION

In the following description, for the purposes of explanation, numerous specific details are set forth in order to provide a thorough understanding of the disclosed embodiments. It will be appreciated, however, by those having skill in the art, that the embodiments may be practiced without these specific details, or with an equivalent arrangement. In other cases, well-known models and devices are shown in block diagram form in order to avoid unnecessarily obscuring the disclosed embodiments. It should also be noted that the methods and systems disclosed herein are also suitable for applications unrelated to source code programming.

FIG. 1 is an example of environment 100 for rule and protocol management using soft-coded rules in non-persistent run-time files. Environment 100 includes dynamic rule management system 110, device 130, server 140, and network 150. Dynamic rule management system 110, device 130, and server 140 may be in communication via the network 150. Network 150 may be a wired or wireless connection, such as via a local area network, a wide area network (e.g., the Internet), or a combination thereof.

Dynamic rule management system 110 may include communication subsystem 112, rule engine subsystem 114, generation subsystem 116, and validation subsystem 118. Dynamic rule management system 110 may execute instructions for rule and protocol management using soft-coded rules in non-persistent run-time files. For example, environment 100 may be used for processing (e.g., validating) one or more inputs, such as software for production releases, for example, to identify performance issues or ensure that the inputs meet certain required standards, such as cybersecurity standards.

Dynamic rule management system 110 may receive a first request to process (e.g., validate) first input data, such as software (e.g., for product releases), using rules, such as validation rules. The request may be made on a user interface (e.g., user interface 132 of device 130), and/or may be transmitted via the network 150 by a user. As referred to herein, input data can include any data, including data able to be validated using one or more validation rules. Input data can include data such as software, data on hardware configurations, license keys, file formats, etc. Validation rules can include one or more conditions or criteria that must be met for input data to be considered valid.

Validation rules may be stored at server 140 (e.g., in database(s) 142). Server 140 may include any physical or virtual computer or system designed to manage and distribute network resources. Database(s) 142 may include a collection of data organized to facilitate retrieval, modification and management. Database(s) 142 may store one or more rules for validation, for example, that the input data may be tested against. According to some examples, database(s) may include a persistent memory database. For example, database(s) 142 may use non-volatile memory (NVM) as a primary storage medium. Additionally, or alternatively, database(s) 142 may include non-persistent memory. In some examples, storing the rule may include storing a plurality of versions of the rule. Furthermore, the system may determine, in response to receiving the first request to process the first input data using the first rule, a version of the plurality of versions (e.g., a most current version). The system may use the determined version to process the first input data. For example, the request may indicate specific versions of a rule to use in processing the data. In some examples, the system may determine a version to use using the input data. For example, the input data may be a function in code in a particular language, and the system may determine based on the programming language, which version of a validation rule to use.

Dynamic rule management system 110 may receive requests via communication subsystem 112. For example, communication subsystem 112 may receive the request for processing the input data. Communication subsystem 112 of dynamic rule management system 110 may include software and/or hardware components allowing for the transmission and/or receipt of information between two or more devices. For example, the communication subsystem 112 may include a wireless communication module, such as a cellular radio or Wi-Fi antenna, to allow for communication over wireless networks, and/or may include a network card (e.g., a wireless network card and/or a wired network card) that is associated with software to drive the card.

According to some embodiments, receiving the first request to process first input data using the first rule may include receiving a first user input selecting a first validation set for the first input data and determining, based on the first validation set, a first when condition, wherein the first when condition indicates one first condition for executing the first rule. For example, the system may determine which when conditions are related to a validation set. The system may retrieve each of these when conditions from the persistent memory database and store them in the non-persistent memory database. For example, the request may include an end user's input (e.g., via a user interface, file, etc.) indicating selections for a set of validation rules to apply. A when condition may indicate a condition on which a validation rule is executed. For example, a when condition may be to apply a rule for checking if the input data includes a valid date and time, when the input data includes a date and time.

In some examples, determining, based on the first validation set, a first when condition includes retrieving, from the persistent memory database, a first database record. The first database record may indicate a plurality of when conditions corresponding to the first validation set. From the first database record, the plurality of when conditions may be retrieved and stored in the non-persistent memory. Alternatively, or additionally, determining the first when condition includes retrieving, from the persistent memory database, a first database record, indicating a plurality of rules corresponding to the first validation set and filtering the plurality of rules based on the first rule template to select the first when condition.

Receiving the first request may also include determining, based on the first input data, that the first when condition is satisfied. For example, the system may process the data and determine that the input data includes a date and time, thus satisfying the when condition. Given that the when condition is satisfied in this case, the system may apply the rule for checking if the input data includes a valid time/date.

Communication subsystem 112 may include software and/or hardware components allowing for the transmission and/or receipt of information between two or more devices (e.g., a wireless communication module, such as a cellular radio or Wi-Fi antenna, a network card). Communication subsystem 112 may pass at least a portion of the data included in the request to process the input data to other subsystems, such as rule engine subsystem 114, generation subsystem 116, and validation subsystem 118.

In response to dynamic rule management system 110 receiving the first request to process input data, for example, such as a request to validate software, the system may retrieve a rule template and initiate a first rule engine session, for example, using communication subsystem 112 and rule engine subsystem 114.

As referred to herein, a rule template may define numerous characteristics about how and what inputted data is validated. For example, the rules template may reference one or more rules for validation stored in persistent memories (e.g., different versions of rules to be used in validation). The rules template may indicate portions of the data that should be validated using the different referenced rules. The system then creates a non-persistent run-time file that includes any current (or selected) versions of the validation rules (e.g., pulled from a persistent database that stores a hard-coded rule). The system may retrieve the rule template in several different ways. In some examples, the request itself may include information regarding what types of processing are required for the given input. In other examples, the system may determine, based on the given input, the processing required and generate and/or retrieve the corresponding rule templates.

As referred to herein, a first rule engine session may include a specific instance of a rule engine where a set of rules (e.g., including the first rule) are evaluated against data, such as the first data. The rule engine subsystem 114 may initiate and end a rule engine session as described herein. The rule engine session may manage the execution of the rules, such as the order in which rules are evaluated, the data that is evaluated, and/or results of the evaluation. By initiating an instance of a rule engine, the system is able to use the rules without hard-coding specific controls for the rules to validate data for a specific context. As such, the system is able to avoid idle time during validation and releasing procedures waiting on rules files to become available. In the example of FIG. 1, the first rule engine session may be initiated to process the input data using the retrieved rule template.

Upon initiating the first rule engine session, the dynamic rule management system 110 may generate a first non-persistent run-time file for validating the first input data using the first rule template. For example, generation subsystem 116 may be used to generate, in a non-persistent memory database, the non-persistent run-time file for validating the first input data using the first rule template. For example, the rule template may outline and define numerous characteristics for how to validate certain portions of data. The template can be used to generate a new file, such as in the form of a script or program that checks the data against the rules outlined in the software and to ensure that the data meets the specified requirements. Because the file is generated and used during run-time and during the first rule engine session, and not saved for future use, the file may be considered non-persistent. In some embodiments, generating the non-persistent run-time file may include determining a format for the input data (e.g., based on the rule template) and reformatting the input data into the first format.

Using the generated non-persistent run-time file may include using validation subsystem 118 to validate the input data. In some examples, validating the first input data using the first non-persistent run-time file includes determining, based on the first validation set, a then condition and processing, based on the then condition, the input data to generate a result. The then condition may indicate a process executed by the first rule.

The system may then generate for display, for example, on user interface 132, a validation confirmation for the first input data and subsequently, rule engine subsystem 114 may end the rule engine session. For example, the validation confirmation may be textual, auditory and/or tactile. For example, the confirmation may include visual indicators that the input data has been validated and conforms to the rules, and/or failed to meet certain standards. In some examples, if the process failed, an error message may be shown to a user.

In some embodiments, the system may receive multiple requests to process different streams or sets of input data. The system may generate a new rule engine session for each inputted data. For example, dynamic rule management system 110 may receive a second request to process second input data using the first rule, for example, via communication subsystem 112 and/or network 150. In one example, the system may receive the second request, after initiating the first rule session, and prior to ending the first rule session, to process second input data using the first rule. Alternatively, or additionally, the system may receive the second request upon validating the first input data using the first non-persistent run-time file.

In response to the second request, the system may retrieve the first rule template as described herein and initiate a second rule engine session using rule engine subsystem 114. Upon initiating the second rule engine session, the system may use generation subsystem 116 to generate, in the non-persistent memory database, a second non-persistent run-time file for validating the second input data using the first rule template. The system may then validate the second input data using the second non-persistent run-time file with validation subsystem 118.

In some embodiments, as the system generates a new rule session and non-persistent run-time file for each set of inputted data, the system may update versions of the rule without affecting validations firstly underway. In particular, the system may further, after initiating the first rule session, and prior to ending the first rule session, receive a version update to the first rule. The version update may include, for example, one or more modifications or changes (e.g., relevant to the specific input data). The system may then store, in the plurality of versions of the first rule in the persistent memory database, a second version of the plurality of versions. For example, the system may use communication subsystem 112 and/or the network 150 to update a preexisting version of the rule, replace a version of the rule, and/or add a new version of the rule in database(s) 142. In some examples, the system may also store information regarding the version update, such as a user identifier for the user who developed an update, a period of time to which the update is associated (e.g., when an update was made, etc.). Alternatively, or additionally, the user may receive the version update upon validating the first input data using the first non-persistent run-time file and store the version update in the persistent memory database (e.g., as a second version).

FIG. 2 illustrates an example of a user interface 200 for rule and protocol management using soft-coded rules in non-persistent run-time files, in accordance with one or more embodiments of this disclosure. The user interface 200 may be user interface 132 of device 130 and may communicate (e.g., transmit a request) to the system via network 150.

For example, a user may use the user interface 200 to make a request, for example, by indicating input data, different rules for validation to use on the data, and/or different versions of the rules, etc. In the example of FIG. 2, the user can set different rules 210 that may be used to process the data with. Each rule can be selected and different controls can be selected and/or adjusted based on the specific data or specific type of processing a user may wish to perform. For example, the right portion of the user interface shows several controls of rule “SOX Attest Validation Failed Releases” that can be implemented and modified to ensure that the software is functioning as intended and meets the requirements of users.

For example, for rule “SOX Attest Validation Failed Releases,” the user may select, for example, from a drop-down menu, a version 252 of the rule. In the example of FIG. 2, the rule version is “3.” The user may also select an expression language 254 (e.g., “mvel”). As described herein, when conditions 256 and then conditions 258 may also be programmed by a user. For example, on user interface 200, a user may input specific conditions into text boxes or input fields of the interface. In some examples, the text box and/or input fields may be prepopulated, for example, with code specifying when and/or then conditions corresponding to the rule. The user may also indicate a result message 260, which may be displayed to a user upon completion of the data processing. The user may also indicate an error message 262, which may be displayed to a user when the data is not able to be processed, or an error is found during the processing.

The user may take several actions during usage of the user interface 200. For example, the user may push any of the “reset changes” button 220, “update rule” button 230, and “disable rule” button 240. The “reset changes” button 220 may revert any changes a user made to the existing rule, such as modifications to the version number, the expression language, when and then conditions, and result and error messages. The “update rule” button 230 may be used to save changes that a user may have made to the preexisting rule. For example, as described herein, the system may transmit the updated rule as a new version to be saved as persistent memory. The “disable” button 240 may disable a rule such that a rule is not used during processing. Similarly, if a rule has been disabled, an “enable” button may be included to enable the rule.

FIG. 3 shows illustrative components for a system used for rule and protocol management using soft-coded rules in non-persistent run-time files, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or a user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or Long-Term Evolution (LTE) network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include aspects of dynamic rule management system 110, such as communication subsystem 112, rule engine subsystem 114, generation subsystem 116, validation subsystem 118, and other components such as server 140, and database(s) 142. Cloud components 310 may access blockchain network 308 (e.g., which in some embodiments may correspond to a blockchain).

Cloud components 310 may include model 302, which may be a machine learning model, artificial intelligence model, deep learning model, etc. (which may be referred to collectively herein as “models”). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., parameters of electrically switchable glass).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302.

In some embodiments, the model (e.g., model 302) may automatically perform actions based on outputs 306. In some embodiments, the model (e.g., model 302) may not perform any actions. The output of the model (e.g., model 302) may be used to determine different parameters of electrically switchable glass of a vehicle, such as position and orientation.

System 300 also includes Application Programming Interface (API) layer 350. API layer 350 may allow the system to generate summaries across different devices. In some embodiments, API layer 350 may be implemented on mobile device 322 or user terminal 324. Alternatively, or additionally, API layer 350 may reside on one or more of cloud components 310. API layer 350 (which may be a REST or Web services API layer) may provide a decoupled interface to data and/or functionality of one or more applications. API layer 350 may provide a common, language-agnostic way of interacting with an application. Web services APIs offer a well-defined contract, called Web Services Description Language (WSDL), that describes the services in terms of its operations and the data types used to exchange information. REST APIs do not typically have this contract; instead, they are documented with client libraries for most common languages, including Ruby, Java, PHP, and JavaScript. Simple Object Access Protocol (SOAP) Web services have traditionally been adopted in the enterprise for publishing internal services, as well as for exchanging information with partners in Business-to-Business (B2B) transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols, such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying Web Application Firewall (WAF) and Distributed Denial of Service (DDOS) protection, and API layer 350 may use RESTful APIs as standard for external integration.

FIG. 4 shows a flowchart of the steps involved in rule and protocol management using soft-coded rules in non-persistent run-time files, in accordance with one or more embodiments. For example, the system may use process 400 (e.g., as implemented on one or more system components described above) to initiate and run rule engine sessions specific to the validation of the input data using a non-persistent run-time file including validation rules, for example, to prevent idle time during validation and releasing procedures waiting on rules files to become available.

At step 402, process 400 (e.g., using one or more components described above) includes storing a first rule in a persistent memory database. In some examples, the first rule may include a validation requirement, such as a first security protocol validation requirement. In some embodiments, the persistent memory database may further store a plurality of versions of the first rule. For example, as described herein, the first rule may include a first security protocol validation requirement and the database may store one or more versions of the rule, for example, corresponding to different iterations of the security protocol validation requirement. The system may select a version of the plurality of versions to use to process the inputted data.

As described herein, in some embodiments, storing the first rule includes storing a plurality of versions of the first rule in the persistent memory database. Storing the first rule may further include determining, in response to receiving the first request to process the first input data using the first rule, a first version of the plurality of versions. For example, in response to receiving the first request as described in step 404, the system may determine which version of several versions a user wishes to use to validate the software. For example, the user may request that a most recent version be used to validate the code. Storing the first rule may further include using the first version to process the first input data. Alternatively, or additionally, the system may select a version of the plurality of versions to use to process the inputted data. Furthermore, if a given validation procedure requires a given version, the system may select that version.

At step 404, process 400 (e.g., using one or more components described above) includes receiving a first request to process first input data using the first rule. For example, the process may include receiving a first request to process first input data using the first rule to determine whether the first input data conforms to the first security protocol validation requirement. By enabling validation requests to identify specific rules and different versions of rules, a user may be able to customize the validation process more effectively and efficiently.

In some embodiments, receiving the first request to process first input data using the first rule includes receiving a first user input selecting a first validation set for the first input data and determining, based on the first validation set, a first when condition, wherein the first when condition indicates one first condition for executing the first rule. Determining the first when condition may include retrieving, from the persistent memory database, a first database record, wherein the first database record indicates a plurality of when conditions corresponding to the first validation set. To determine the first when condition, the system may retrieve, from the first database record, the plurality of when conditions and store the plurality of when conditions in the non-persistent memory. For example, the system may determine which when conditions are related to a validation set. The system may retrieve each of these when conditions from the persistent memory database and store them in the non-persistent memory database.

Alternatively, or additionally, determining, based on the first validation set, a first when condition, may include retrieving, from the persistent memory database, a first database record, wherein the first database record indicates a plurality of rules corresponding to the first validation set, and filtering the plurality of rules based on the first rule template to select the first when condition. For example, the system may determine which when conditions are related to particular inputted data based on the rule template being applied. For example, the rule template may indicate specific rules and/or conditions that are required to validate the inputted data.

Receiving the first request may also include determining, based on the first input data, that the first when condition is satisfied. For example, the system may provide a user interface that allows for one or more validation sets (e.g., sets of rules) to be applied to an inputted data stream. The system may receive a first request, for example, via user input on an API or user interface, to process (e.g., validate) first input data, such as software for a product release. The user may select, for example, via a user interface, one or more rules (e.g., one or more validation set).

At step 406, process 400 (e.g., using one or more components described above) includes retrieving a first rule template. For example, the system may retrieve a first rule template in response to the first request. For example, the rules template may define numerous characteristics about how and what inputted data is validated. For example, the rules template may reference one or more rules for validation stored in persistent memories (e.g., different versions of rules to be used in validation). The system then creates a non-persistent run-time file that includes any current (or selected) versions of the validation rules (e.g., pulled from a persistent database that stores a hard-coded rule). By doing so, the system may initiate a rule engine session specific to the validation of the inputted data and avoid idle time during validation and releasing procedures waiting on rules files to become available.

At step 408, process 400 (e.g., using one or more components described above) includes initiating a first rule engine session. For example, the system may initiate a first rule engine session in response to the first request. As described herein, a rule engine session may include a specific instance of a rule engine where a set of rules (e.g., including the first rule) are evaluated against data, such as the first data. For example, the rule engine session may manage the execution of the rules, such as the order in which rules are evaluated, the data that is evaluated, and/or results of the evaluation. By initiating an instance of a rule engine, the system is able to use the rules without hard-coding specific controls for the rules to validate data for a specific context. As such, the system is able to avoid idle time during validation and releasing procedures waiting on rules files to become available.

At step 410, process 400 (e.g., using one or more components described above) includes generating a first non-persistent run-time file for validating the first input data using the first rule template. For example, the system may, upon initiating the first rule engine session, generate, in a non-persistent memory database, a first non-persistent run-time file for validating the first input data using the first rule template. By doing so, the system may validate the data (e.g., software) without modifying the original file, which may reduce the risk of data loss or corruption and allow multiple validation sessions at the same time.

In some embodiments, generating the first non-persistent run-time file for validating the first input data using the first rule template further includes determining, based on the first rule template, a first format for the inputted data and reformatting the inputted data into the first format. For example, the rule template may define numerous characteristics about how and what inputted data is validated. In some embodiments, the rule template may describe a format of the inputted data for validating.

At step 412, process 400 (e.g., using one or more components described above) includes validating the first input data using the first non-persistent run-time file. For example, the system may generate a temporary file to validate data (e.g., software). The temporary file would be created each time a request for validation was received and the temporary file would be deleted after performing the validation.

In some embodiments, validating the first input data using the first non-persistent run-time file includes determining, based on the first validation set, a first then condition, wherein the first then condition indicates a process executed by the first rule and processing, based on the first then condition, the first input data to generate a first result. For example, at run-time, the system may determine which then conditions are performed based on the first rule.

At step 414, process 400 (e.g., using one or more components described above) includes generating for display a validation confirmation for the first input data. For example, the system may generate the validation confirmation for display on a user interface. The user interface may show an indication, such as a notification or message that validation was successful, unsuccessful, or if there was an error during the run-time process. By doing so, the system may alert the user as to whether or not the input data, such as software, meets the standards for being integrated with the computer system at large. The system may provide specific data as to which tests against specific rules passed or failed.

At step 416, process 400 (e.g., using one or more components described above) includes ending the first rule engine session. For example, the system may establish and run rule engine sessions that are only active while a validation is performed. By doing so, the system may minimize the computing resources used to maintain a plurality of different sessions, but also enable the compartmentation needed to perform different validations with different versions of rules.

In some embodiments, the system may receive multiple requests to process different streams or sets of input data. The system may generate a new rule engine session for each inputted data. For example, in some embodiments, the process 400 may further include receiving a second request to process second input data using the first rule and in response to the second request retrieving the first rule template (e.g., after initiating the first rule session, and prior to ending the first rule session) and initiating a second rule engine session. The method may include generating, upon initiating the second rule engine session, in the non-persistent memory database, a second non-persistent run-time file for validating the second input data using the first rule template and validating the second input data using the second non-persistent run-time file. In some embodiments, the system may receive the second request, initiate the second rule engine session, generate the second non-persistent run-time file, and validate the second input data upon validating the first input data using the first non-persistent run-time file.

In some embodiments, the process 400 may further include, after initiating the first rule session, and prior to ending the first rule session, receiving a version update to the first rule and storing, in the plurality of versions of the first rule in the persistent memory database, a second version of the plurality of versions. For example, as the system generates a new rule session and non-persistent run-time file for each set of inputted data, the system may update versions of the rule without affecting validations firstly underway.

In some embodiments, the process 400 may include upon validating the first input data using the first non-persistent run-time file, receiving a version update to the first rule, and storing, in the plurality of versions of the first rule in the persistent memory database, a second version of the plurality of versions.

In some embodiments, the process 400 may include, upon validating the first input data using the first non-persistent run-time file receiving a version update to the first rule and in response to receiving the version update, and upon continuing to validate the first input data using the first rule, storing, in the plurality of versions of the first rule in the persistent memory database, a second version of the plurality of versions.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for dynamic rule management without using hard-coded rules, the method comprising: storing, in a persistent memory database, a first rule; receiving a first request to process first input data using the first rule; in response to the first request: retrieving a first rule template; and initiating a first rule engine session; upon initiating the first rule engine session, generating, in a non-persistent memory database, a first non-persistent run-time file for validating the first input data using the first rule template; validating the first input data using the first non-persistent run-time file; generating for display, on a user interface, a validation confirmation for the first input data; and ending the first rule engine session.
2. The method of any one of the preceding embodiments, wherein receiving the first request to process first input data using the first rule comprises: receiving a first user input selecting a first validation set for the first input data; determining, based on the first validation set, a first when condition, wherein the first when condition indicates one first condition for executing the first rule; and determining, based on the first input data, that the first when condition is satisfied.
3. The method of any one of the preceding embodiments, wherein determining, based on the first validation set, a first when condition, comprises: retrieving, from the persistent memory database, a first database record, wherein the first database record indicates a plurality of when conditions corresponding to the first validation set; retrieving, from the first database record, the plurality of when conditions; and storing the plurality of when conditions in the non-persistent memory.
4. The method of any one of the preceding embodiments, wherein determining, based on the first validation set, a first when condition, comprises: retrieving, from the persistent memory database, a first database record, wherein the first database record indicates a plurality of rules corresponding to the first validation set; and filtering the plurality of rules based on the first rule template to select the first when condition.
5. The method of any one of the preceding embodiments, wherein validating the first input data using the first non-persistent run-time file comprises: determining, based on the first validation set, a first then condition, wherein the first then condition indicates a process executed by the first rule; processing, based on the first then condition, the first input data to generate a first result.
6. The method of any one of the preceding embodiments, wherein generating the first non-persistent run-time file for validating the first input data using the first rule template further comprises: determining, based on the first rule template, a first format for the inputted data; and reformatting the inputted data into the first format.
7. The method of any one of the preceding embodiments, further comprising: receiving a second request to process second input data using the first rule; in response to the second request: retrieving the first rule template and initiating a second rule engine session; upon initiating the second rule engine session, generating, in the non-persistent memory database, a second non-persistent run-time file for validating the second input data using the first rule template; and validating the second input data using the second non-persistent run-time file.
8. The method of any one of the preceding embodiments, wherein storing the first rule comprises: storing a plurality of versions of the first rule in the persistent memory database; determining, in response to receiving the first request to process the first input data using the first rule, a first version of the plurality of versions; and using the first version to process the first input data.
9. The method of any one of the preceding embodiments, further comprising: after initiating the first rule session, and prior to ending the first rule session, receiving a version update to the first rule; and storing, in the plurality of versions of the first rule in the persistent memory database, a second version of the plurality of versions.
10. The method of any one of the preceding embodiments, further comprising: after initiating the first rule session, and prior to ending the first rule session, receiving a second request to process second input data using the first rule; in response to the second request: retrieving the first rule template and initiating a second rule engine session; upon initiating the second rule engine session, generating, in the non-persistent memory database, a second non-persistent run-time file for validating the second input data using the first rule template and the second version; and validating the first input data using the second non-persistent run-time file.
11. The method of any one of the preceding embodiments, wherein storing the first rule comprises: storing a plurality of versions of the first rule in the persistent memory database; and determining, based on the first request, a first version of the plurality of versions to process the first input data.
12. The method of any one of the preceding embodiments, further comprising: upon validating the first input data using the first non-persistent run-time file, receiving a version update to the first rule; and storing, in the plurality of versions of the first rule in the persistent memory database, a second version of the plurality of versions.
13. The method of any one of the preceding embodiments, further comprising: upon validating the first input data using the first non-persistent run-time file, receiving a second request to process second input data using the first rule; in response to the second request, retrieving the first rule template and initiating a second rule engine session; upon initiating the second rule engine session, generating, in the non-persistent memory database, a second non-persistent run-time file for validating the second input data using the first rule template and the second version; and validating the first input data using the second non-persistent run-time file.
14. A tangible, non-transitory, machine-readable medium storing instructions that, when executed by a data processing apparatus, cause the data processing apparatus to perform operations comprising those of any of embodiments 1-13.
15. A system comprising one or more processors and memory-storing instructions that, when executed by the processors, cause the processors to effectuate operations comprising those of any of embodiments 1-13.
16. A system comprising means for performing any of embodiments 1-13.

What is claimed is:

1. A system for dynamic cybersecurity rule and protocol management through soft-coded rules in non-persistent run-time files, the system comprising:
one or more processors; and
a non-transitory, computer readable medium comprising instructions that, when executed by the one or more processors, causes operations comprising:
storing a plurality of versions of a first rule in a persistent memory database, wherein the first rule comprises a first security protocol validation requirement;
receiving a first request to process first input data using the first rule to determine whether the first input data conforms to the first security protocol validation requirement;
determining, based on the first request, a first version of the plurality of versions to process the first input data;
in response to the first request:
retrieving a first rule template, and
initiating a first rule engine session;
upon initiating the first rule engine session, generating, in a non-persistent memory database, a first non-persistent run-time file for validating the first input data using the first rule template and the first version;
validating the first input data using the first non-persistent run-time file;
upon validating the first input data using the first non-persistent run-time file:
receiving a version update to the first rule, and
in response to receiving the version update, and upon continuing to validate the first input data using the first rule, storing, in the plurality of versions of the first rule in the persistent memory database, a second version of the plurality of versions;
generating for display, on a user interface, a validation confirmation for the first input data; and
ending the first rule engine session.

2. A method for dynamic rule management without using hard-coded rules, the method comprising:
storing, in a persistent memory database, a first rule;
receiving a first request to process first input data using the first rule;
in response to the first request:
retrieving a first rule template, and
initiating a first rule engine session;
upon initiating the first rule engine session, generating, in a non-persistent memory database, a first non-persistent run-time file for validating the first input data using the first rule template;
validating the first input data using the first non-persistent run-time file;
generating for display, on a user interface, a validation confirmation for the first input data; and
ending the first rule engine session.

3. The method of claim 2, wherein receiving the first request to process the first input data using the first rule comprises:
receiving a first user input selecting a first validation set for the first input data;
determining, based on the first validation set, a first when condition, wherein the first when condition indicates one first condition for executing the first rule; and
determining, based on the first input data, that the first when condition is satisfied.

4. The method of claim 3, wherein determining, based on the first validation set, a first when condition, comprises:
retrieving, from the persistent memory database, a first database record, wherein the first database record indicates a plurality of when conditions corresponding to the first validation set;
retrieving, from the first database record, the plurality of when conditions; and
storing the plurality of when conditions in the non-persistent memory database.

5. The method of claim 3, wherein determining, based on the first validation set, a first when condition, comprises:
retrieving, from the persistent memory database, a first database record, wherein the first database record indicates a plurality of rules corresponding to the first validation set; and
filtering the plurality of rules based on the first rule template to select the first when condition.

6. The method of claim 3, wherein validating the first input data using the first non-persistent run-time file comprises:
determining, based on the first validation set, a first then condition, wherein the first then condition indicates a process executed by the first rule; and
processing, based on the first then condition, the first input data to generate a first result.

7. The method of claim 2, wherein generating the first non-persistent run-time file for validating the first input data using the first rule template further comprises:
determining, based on the first rule template, a first format for the first input data; and
reformatting the first input data into the first format.

8. The method of claim 2, further comprising:
receiving a second request to process second input data using the first rule;
in response to the second request:
retrieving the first rule template, and
initiating a second rule engine session;
upon initiating the second rule engine session, generating, in the non-persistent memory database, a second non-persistent run-time file for validating the second input data using the first rule template; and
validating the second input data using the second non-persistent run-time file.

9. The method of claim 2, wherein storing the first rule comprises:
storing a plurality of versions of the first rule in the persistent memory database;
determining, in response to receiving the first request to process the first input data using the first rule, a first version of the plurality of versions; and
using the first version to process the first input data.

10. The method of claim 9, further comprising:
after initiating the first rule engine session, and prior to ending the first rule engine session, receiving a version update to the first rule; and
storing, in the plurality of versions of the first rule in the persistent memory database, a second version of the plurality of versions.

11. The method of claim 10, further comprising:
after initiating the first rule engine session, and prior to ending the first rule engine session, receiving a second request to process second input data using the first rule;
in response to the second request:
retrieving the first rule template, and
initiating a second rule engine session;
upon initiating the second rule engine session, generating, in the non-persistent memory database, a second non-persistent run-time file for validating the second input data using the first rule template and the second version; and
validating the first input data using the second non-persistent run-time file.

12. The method of claim 2, wherein storing the first rule comprises:
storing a plurality of versions of the first rule in the persistent memory database; and
determining, based on the first request, a first version of the plurality of versions to process the first input data.

13. The method of claim 12, further comprising:
upon validating the first input data using the first non-persistent run-time file:
receiving a version update to the first rule; and
storing, in the plurality of versions of the first rule in the persistent memory database, a second version of the plurality of versions.

14. The method of claim 13, further comprising:
upon validating the first input data using the first non-persistent run-time file:
receiving a second request to process second input data using the first rule;
in response to the second request:
retrieving the first rule template, and
initiating a second rule engine session;
upon initiating the second rule engine session, generating, in the non-persistent memory database, a second non-persistent run-time file for validating the second input data using the first rule template and the second version; and
validating the first input data using the second non-persistent run-time file.

15. A non-transitory, computer readable medium comprising instructions that, when executed by one or more processors, causes operations comprising:
storing, in a persistent memory database, a first rule;
receiving a first request to process first input data using the first rule;
in response to the first request:
retrieving a first rule template, and
initiating a first rule engine session;
upon initiating the first rule engine session, generating, in a non-persistent memory database, a first non-persistent run-time file for validating the first input data using the first rule template;
validating the first input data using the first non-persistent run-time file;
generating for display, on a user interface, a validation confirmation for the first input data; and
ending the first rule engine session.

16. The non-transitory, computer readable medium of claim 15, wherein receiving the first request to process first input data using the first rule comprises:
receiving a first user input selecting a first validation set for the first input data;
determining, based on the first validation set, a first when condition, wherein the first when condition indicates one first condition for executing the first rule; and
determining, based on the first input data, that the first when condition is satisfied.

17. The non-transitory, computer readable medium of claim 16, wherein determining, based on the first validation set, a first when condition, comprises:
retrieving, from the persistent memory database, a first database record, wherein the first database record indicates a plurality of when conditions corresponding to the first validation set;
retrieving, from the first database record, the plurality of when conditions; and
storing the plurality of when conditions in the non-persistent memory database.

18. The non-transitory, computer readable medium of claim 17, wherein determining, based on the first validation set, a first when condition, comprises:
retrieving, from the persistent memory database, a first database record, wherein the first database record indicates a plurality of rules corresponding to the first validation set; and
filtering the plurality of rules based on the first rule template to select the first when condition.

19. The non-transitory, computer readable medium of claim 17, wherein validating the first input data using the first non-persistent run-time file comprises:
determining, based on the first validation set, a first then condition, wherein the first then condition indicates a process executed by the first rule; and
processing, based on the first then condition, the first input data to generate a first result.

20. The non-transitory, computer readable medium of claim 15, wherein storing the first rule comprises:
storing a plurality of versions of the first rule in the persistent memory database; and
determining, based on the first request, a first version of the plurality of versions to process the first input data.
